(19) United States
(12) Patent Application Publication
(10) Pub. No.: US 2007/0225893 A1
(43) Pub. Date: Sep. 27, 2007

(54) Apparatus and method for providing course information application

(75) Inventor: Sung-il Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/707,166

(22) Filed: Feb. 16, 2007

Related U.S. Application Data
(60) Provisional application No. 60/780,347, filed on Mar. 9, 2006.

(30) Foreign Application Priority Data
Jul. 6, 2006 (KR) 10-2006-0063486

(51) Int. Cl. G08G 1/00

(52) U.S. Cl. 701/117

(57) ABSTRACT

An apparatus and method for providing a course information application, including course information based on an event, are provided. The course information providing apparatus comprises a signal processing unit which receives and analyzes a course information application, which comprises at least one piece of event information and at least one piece of course information for each piece of the event information; a controller which forms a screen image for providing the course information application; and an output unit which outputs the screen image for providing the course information application. Accordingly, an apparatus and method for providing CRI which reflects a traffic situation for an event occurring in the future are provided.

### CROSS-REFERENCE TO RELATED PATENT APPLICATIONS

This application is based on and claims priority from Korean Patent Application No. 10-2006-0063486, filed on Jul. 6, 2006 in the Korean Intellectual Property Office; and U.S. Provisional Patent Application No. 60/780,347, filed on Mar. 9, 2006 in the U.S. Patent and Trademark Office, the disclosures of which are hereby incorporated by reference in their entirety.

### BACKGROUND OF THE INVENTION

1. Field of the Invention

Apparatuses and methods consistent with the present invention relate to providing traffic information, and more particularly, providing a course information application, whereby course information based on an event is provided.

2. Description of the Related Art

Digital multimedia broadcasting (DMB) is a broadcasting service for modulating various multimedia signals, such as voice and images, onto a DMB signal, and providing the DMB signal to fixed and portable receivers. An advantage of DMB is that a DMB signal can be received by a mobile or portable receiver.

One service provided using DMB is a traffic and travel information service for providing traffic and travel information. However, the traffic and travel information service provides only information about a simple current traffic situation, such as current traffic accident information, road construction information, and weather information. Thus, if a user wants to go to a destination in which a specific event occurs, the user should determine a course using a navigation terminal or a road map.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an apparatus and method for providing a course information application, whereby course information based on an event is provided.

According to an aspect of the present invention, there is provided a course information providing apparatus comprising a signal processing unit which receives and analyzes a course information application comprising at least one piece of event information, and at least one piece of course information for each piece of the event information; a controller which forms a screen image for providing the course information application; and an output unit which outputs the screen image for providing the course information application.

According to another aspect of the present invention, there is provided a course information providing method comprising receiving and analyzing a course information application comprising at least one piece of event information, and at least one piece of course information for each piece of the event information; forming a screen image for providing the course information application; and outputting the screen image for providing the course information application.

According to another aspect of the present invention, there is provided a computer readable recording medium which stores programs for executing a course information providing method, comprising receiving and analyzing a course information application comprising at least one piece of event information, and at least one piece of course information for each piece of the event information; forming a screen image for providing the course information application; and outputting the screen image for providing the course information application.

According to another aspect of the present invention, there is provided a frame structure having a plurality of fields, the frame structure comprising an event field comprising at least one piece of event information, and at least one course information field for each piece of the event information.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a system for generating a course information application according to an exemplary embodiment of the present invention;

FIG. 2 illustrates the syntax of a course information application according to an exemplary embodiment of the present invention;

FIG. 3 illustrates the detailed syntax of the course information application illustrated in FIG. 2, according to an exemplary embodiment of the present invention;

FIG. 4 is a block diagram of an apparatus for providing a course information application according to an exemplary embodiment of the present invention;

FIG. 5 illustrates a screen image through which a course information application is provided according to an exemplary embodiment of the present invention;

FIGS. 6A and 6B illustrate screen images through which a course information application is provided according to an exemplary embodiment of the present invention;

FIG. 7 illustrates a screen image through which a course information application is provided as an image according to an exemplary embodiment of the present invention;

FIGS. 8A and 8B illustrate screen images through which a course information application is provided as an image according to an exemplary embodiment of the present invention; and

FIG. 9 is a flowchart illustrating a method of providing a course information application according to an exemplary embodiment of the present invention.

### DETAILED DESCRIPTION OF EXEMPLARY EMBODIMENTS OF THE INVENTION

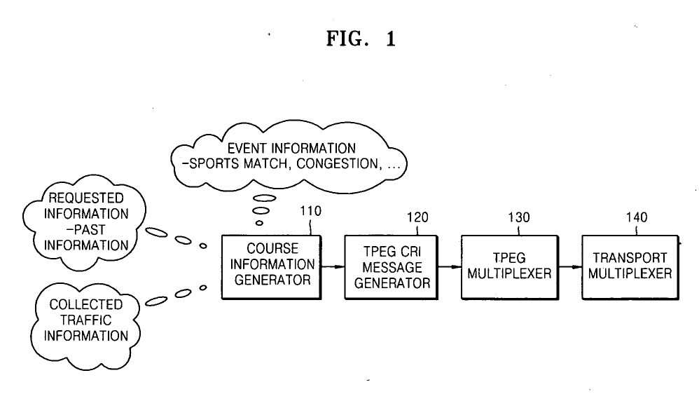

FIG. 1 is a block diagram of a system for generating a course information application according to an exemplary embodiment of the present invention.

Data of a Transport Protocol Experts Group (TPEG) service includes messages containing traffic information. The messages can be classified according to message type, and a message classified according to message type is called an application. For example, a message for providing information on public transport systems is referred to as a TPEG PTI (public transport information) application.

A message for providing information on course information according to an exemplary embodiment of the present invention is referred to as a course information application or TPEG course recommended information (CRI) in the present specification.

Referring to FIG. 1, the system for generating a course information application includes a course information generator 110, a TPEG CRI message generator 120, a TPEG multiplexer 130, and a transport multiplexer 140.

The course information generator 110 generates information on courses in which an event occurs by using information on traffic situations collected from several paths. This information includes current event information, such as a match, festival, demonstration, and traffic congestion in a specific area; past information, such as information on past road traffic situations; and requested information, in a case where a user requests specific traffic information. Thus, the course information generator 110 can generate information on recommended courses or courses to detour at an event place by referring to prediction information based on current traffic information and past traffic information.

The TPEG CRI message generator 120 generates a message according to a TPEG CRI message structure, using the course information generated by the course information generator 110. The TPEG multiplexer 130 generates a stream by reconstructing the generated TPEG CRI message and other traffic information messages as a frame according to a TPEG framework. Here, the other traffic information messages include a TPEG RTM (road traffic message), which is a message for road traffic information, a TPEG PTI, which is a message for public transport information, and other information messages used to provide traffic information.

The transport multiplexer 140 multiplexes the generated stream according to a transport scheme such as digital audio broadcasting (DAB), DMB, or digital video broadcasting-handhelds (DVB-H); or a method of transporting a data stream provided in Internet protocol (IP) data casting, in which a TPEG CRI message multiplexed according to a TPEG protocol is delivered to users. For example, when a DMB channel is used, the transport multiplexer 140 creates an MPEG-2 transport stream by creating a TPEG transport stream from the TPEG CRI message, carrying the created TPEG transport stream on a DMB sub-channel through which data can be transmitted, and multiplexing the created TPEG transport stream with other information, such as a video stream or audio stream. The transport multiplexer 140 then transmits the created MPEG-2 transport stream.

A course information application according to an exemplary embodiment of the present invention provides a recommended course based on an event. For example, if a Worldcup match is scheduled, or if traffic at a specific location is congested, a user who desires to see the Worldcup match at the match location, or who has chosen a specific location as a destination, can obtain information on recommended courses and courses to detour as traffic information oriented to the location at which an event occurs using the course information application. Since a user can select information of recommended courses provided by the system for generating a course information application, which is illustrated in FIG. 1, by using the course information generator 110 which considers various situations, the information on recommended courses is more useful than course information provided by a common navigation terminal.

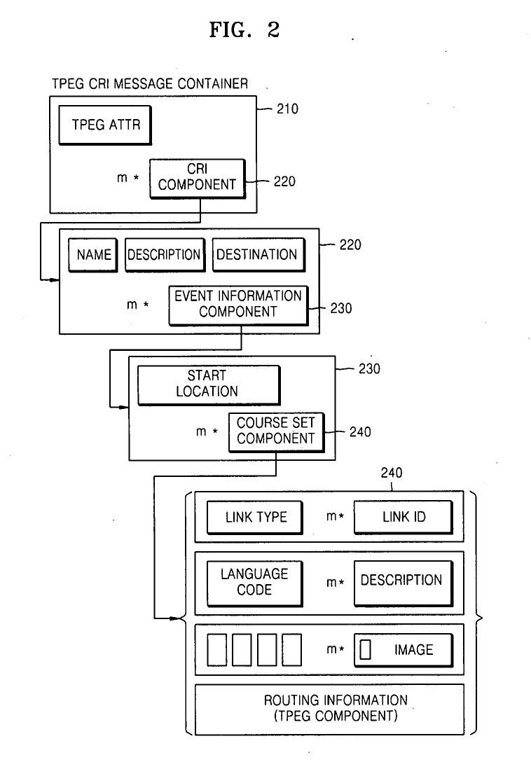

FIG. 2 illustrates the syntax of a course information application according to an exemplary embodiment of the present invention.

Referring to FIG. 2, a TPEG CRI message container 210 which contains a TPEG CRI message according to an exemplary embodiment of the present invention includes TPEG attribute information, which is attribute information of the TPEG CRI message, and a predetermined number m of CRI components 220. The TPEG attribute information may include basic information generally provided by the TPEG protocol, such as a message identification (ID), which is identification information of the course information application; time information of a valid time of a currently transmitted message, including the course information application; and version information of the course information application.

Each of the CRI components 220 is a container which contains a recommended course service message, and includes a name, description, and destination of an event. Each of the CRI components 220 also includes at least one event information component 230.

Each of the event information components 230 includes start position information, which is attribute information on course information, and at least one course set component 240.

Each of the course set components 240 includes at least one course provided in the form of at least one of link information, text information, image information, and routing information.

Providing course information as link information indicates that the system for generating a course information application, which is illustrated in FIG. 1, edits and transmits a list of link IDs that are uniquely defined to denote roads in every city or nation. In this case, if a device for providing a course information application, which is a user terminal, supports the link IDs, information on recommended courses can be displayed to the user so that the user can easily understand the information. If the user terminal can be interfaced with a navigation module, the link IDs and map data can be directly linked and provided together.

Course information may be provided as text information. In this case, the system for generating a course information application sequentially transmits text information about a course, such as road names or landmarks, about a course. An apparatus for providing a course information application can provide text type course information to a user by analyzing the course information application. The text type course information can include information such as moving direction information at each intersection, or information on how many meters the user should move on the road.

For example, the following text information can be transmitted to the apparatus for providing a course information application:

“1) move in the North Suwon direction along Park Ji-sung Road; 2) go straight at the intersection having an [Incheon, Seoul] sign; 3) go straight at the intersection having an table of a distances [Incheon, East Suwon] sign; 4) prepare to make a left turn when North Suwon mart is seen; 5) go straight at the intersection having a OO auto repair center on the left; 6) go straight 100 m, Suwon stadium can be seen on your right.”

Course information may be provided as image information. In this case, image data can be directly transmitted through a broadcasting network, or provided as locator information by which an apparatus for providing a course information application can access a device having the image data in order to receive it through another path.

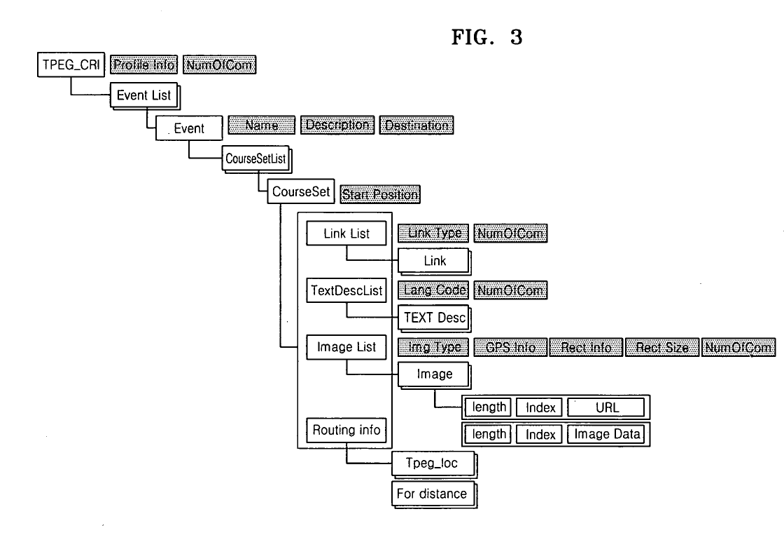

FIG. 3 illustrates the detailed syntax of the course information application illustrated in FIG. 2, according to an exemplary embodiment of the present invention.

Referring to FIG. 3, the course information application contains attribute information, including profile information ‘Profile Info’ and information on the number of components ‘NumOfCom’.

The profile information ‘Profile Info’ includes information on receiver terminals capable of receiving and processing the course information application. The information on the number of components ‘NumOfCom’ indicates the number of components contained in the container. An event list ‘Event List’ is a list in which at least one event is listed, and indicates that the course information application includes the at least one event. The information on the number of components ‘NumOfCom’ of the course information application indicates the number of events included in the event list ‘Event List’.

Each event has attribute information including at least one of name information ‘Name’, description information ‘Description’, and destination information ‘Destination’, as illustrated in FIG. 2. The description information ‘Description’ contains a more detailed description of the event. The destination information ‘Destination’ is information on a place in which the event occurs. For example, the name information ‘Name’ contains “Worldcup match”, the description information ‘Description’ contains “the last event to play in the Worldcup finals”, and the destination information ‘Destination’ contains “Seoul Worldcup stadium”.

Each event includes at least one list of course sets ‘CourseSetList’, which is a list of course information. Each of the course set lists ‘CourseSetList’ includes various course sets ‘CourseSet’ provided by the system for generating a course information application. Each of the course sets ‘CourseSet’ contains attribute information, including start position information ‘Start Position’, and can also include attribute information, such as information indicating that a provided course is the shortest course or a detour.

Each of the course sets ‘CourseSet’ includes at least one of link information ‘Link List’, text information ‘TextDescList’, image information ‘Image List’, and routing information ‘Routing Info’.

A link type ‘Link Type’, which is attribute information of the link information ‘Link List’, indicates a type of link ID included in the link information ‘Link List’. For example, the link type ‘Link Type’ may be information on the Korean standard node link system.

A language code ‘Lang Code’, which is attribute information of the text information ‘TextDescList’, indicates an encoding method of the text information ‘TextDescList’, or information on the text information ‘TextDescList’.

Attribute information of the image information ‘Image List’ contains at least one of an image type ‘Img Type’, Global Positioning System (GPS) information ‘GPS Info’, rectangle information ‘RectInfo’, rectangle size ‘RectSize’, and the number of components ‘NumOfCom’.

The image type ‘Img Type’ indicates a type of an image and whether the image is received through a bi-directional communication network or a broadcasting network. Whether the image is received from a bi-directional communication network or a broadcasting network can be represented using the most significant bit among bits for representing the image type ‘Img Type’.

When the image type ‘Img Type’ indicates that the image is received through a broadcasting network, image data included in the image information ‘Image List’ has a predetermined image format. When the image type ‘Img Type’ indicates that the image is received through a bi-directional communication network, image data may be locator information, such as a Uniform Resource Locator (URL), indicating a locator used to obtain the image data.

The GPS information ‘GPS Info’ is information on an exact position on a map image, and indicates a GPS data value.

The rectangle, information ‘RectInfo’ is information on a relative location of a rectangle, such as row and column information of the rectangle, within a map provided by the image data where the map is divided into partial maps having a predetermined size. The rectangle size ‘RectSize’ is information on the size of the rectangle where the map is divided into partial maps having a predetermined size.

When an image is divided and received, the attribute information of the image information ‘Image List’ can also contain index information ‘Index’ with an index number for indicating an arranged order or position of a divided image obtained by dividing the image. For example, if the rectangle information ‘RectInfo’ contains information indicating that 3×3 map data is transmitted, and if the index information ‘Index’ contains 1, 3, and 9, this indicates that among information on the map formed with 9 rectangles, only map information of first, third, and ninth rectangles is transmitted. A numbering method can be determined by a predetermined method. For example, when a map is equally divided into three parts in a horizontal direction and a vertical direction, numbers can be set to sequentially increase toward the right.

The routing information ‘Routing Info’ includes TPEG location information ‘Tpeg_loc’ for representing a location on the map under the TPEG standard, and distance information ‘For distance’, which is information on a total length of a routed road.

Each piece of information included in the syntax of a course information application can have a structure as illustrated in FIGS. 2 and 3, and this structure can be variously changed. In addition, the course information application according to an exemplary embodiment of the present invention can be formed with a frame structure having a plurality of fields and subsequently transmitted. In this case, data containing event information and course information included in the course information application can be embedded in fields forming a frame and subsequently transmitted.

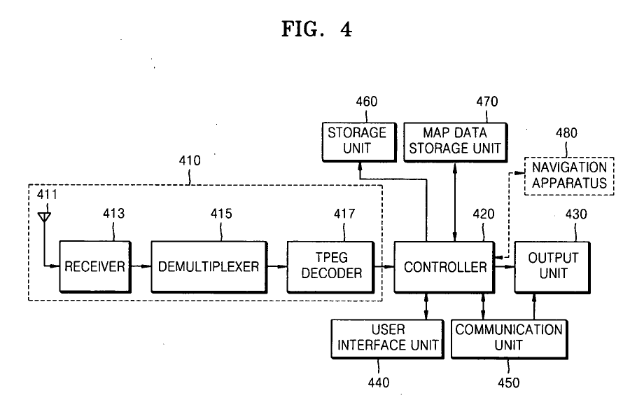

FIG. 4 is a block diagram of an apparatus for providing a course information application according to an exemplary embodiment of the present invention.

Referring to FIG. 4, the apparatus for providing a course information application includes a signal processing unit 410, a controller 420, an output unit 430, a user interface unit 440, a communication unit 450, a storage unit 460, and a map data storage unit 470.

The signal processing unit 410 receives and processes a broadcasting signal which includes a course information application containing course information of a predetermined event. Here, the course information application is transmitted using the TPEG protocol.

If a traffic and travel information service is provided through a digital broadcasting signal, the signal processing unit 410 includes an antenna 411 receiving the digital broadcasting signal, a receiver 413, a demultiplexer 415, and a TPEG decoder 417. The receiver 413 can include a tuner (not shown) which outputs one of a plurality of broadcasting signals by tuning one of a plurality of channels and a channel decoder (not shown) which performs channel decoding according to a predetermined method. The demultiplexer 415 demultiplexes a signal obtained by the channel-decoding, and outputs data streams including a video stream, an audio stream, and a TPEG data stream.

The video stream and the audio stream are decoded by a video decoder (not shown) and an audio decoder (not shown), respectively. The TPEG data stream is decoded by the TPEG decoder 417. In other exemplary embodiments of the present invention, the configuration of the signal processing unit 410 can be changed, depending on the method used to transmit the traffic and travel information service including the course information application.

The controller 420 forms a screen image for providing the course information application decoded from the TPEG data stream by the signal processing unit 410. The controller 420 controls data transmission and reception with the signal processing unit 410, the output unit 430, the user interface unit 440, the communication unit 450, the storage unit 460, and the map data storage unit 470.

The output unit 430 outputs the screen image for providing the course information application, which is formed by the controller 420. The output unit 430 also outputs audio and video data which it receives from the audio and video decoders.

The user interface unit 440 is a user input device, such as a keypad or a touch screen, and receives a user input signal for requesting the course information application.

The storage unit 460 stores information on at least one event and information on at least one course corresponding to the event information, which are obtained by analyzing the course information application using the signal processing unit 410. The controller 420 can form the screen image for providing the course information application using course information obtained by the analysis made by the signal processing unit 410 or using course information stored in the storage unit 460.

The course information application can be provided as described below. If a user input signal for requesting the course information application of the traffic and travel information service is input through the user interface unit 440 during a broadcasting service, the controller 420 forms a screen image for providing an event list, including information on at least one event from the course information obtained by the analysis made by the signal processing unit 410, and outputs the formed screen image to the output unit 430.

If a user input signal for selecting at least one event included in the event list is input through the user interface unit 440, the controller 420 forms a screen image for providing at least one of destination information, description information, and course information of the selected event, which are obtained by analyzing the course information application in response to the user input signal, and outputs the formed screen image to the output unit 430. If course information based on a start location is selected from among the provided course information through the user interface unit 440, the controller 420 can provide the selected course information to a user by forming a screen image for providing course information analyzed from the course information application, and outputting the formed screen image to the output unit 430. The screen image for providing course information can be formed in various patterns according to link ID, image data, text, or routing information obtained by the analysis made by the signal processing unit 410.

The map data storage unit 470 stores location information about the link ID, and map data about the location information. If the course information obtained by the analysis made by the signal processing unit 410 includes link information, the controller 420 provides map data through the output unit 430 by searching for the location information about the link ID and the map data about the location information from the map data storage unit 470 using the link ID, and outputting the location information and map data found by the searching to the output unit 430. The apparatus for providing a course information application according to an exemplary embodiment of the present invention can provide map data about a link ID to the user by connecting to an external navigation device 480, even without including the map data storage unit 470.

If the course information includes locator information indicating a locator used to obtain image data showing a course, the communication unit 450 connects to an external device based on the locator information and receives image data. For example, if locator information such as a URL is included to obtain image data, the controller 420 controls the communication unit 450 to make it connect to a communication server having the URL and receive image data. The received image data is output to the output unit 430 and provided to the user.

If image information contains location information for representing a location on a map, such as the GPS information ‘GPS Info’ illustrated in FIG. 3, the controller 420 can check current location information of the user from the navigation device 480 for checking a current location of the user and form image data, including a screen image for providing the current location of the user, using the current location information of the user and the location information contained in the image information.

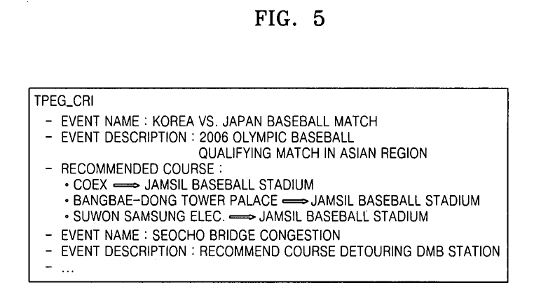

FIG. 5 illustrates a screen image in which a course information application is provided according to an exemplary embodiment of the present invention.

Referring to FIGS. 2, 4, and 5, if a user input signal for requesting a course information application is input through the user interface unit 440, the controller 420 can form a screen image as illustrated in FIG. 5 for providing the course information application obtained by the analysis made by the signal processing unit 410, and provide the formed screen image to the user.

Information such as name information, for example “Korea vs. Japan baseball match,” description information, for example “a 2006 Olympic baseball qualifying match of the Asian region,” and destination information, for example “Jamsil baseball stadium”, are displayed on a screen for an event of a CRI component 220. In addition, recommended courses for moving from start locations such as “COEX”, “Bangbae-dong Tower palace”, or “Suwon Samsung Elec.” to a destination such as “Jamsil baseball stadium” are provided as an event information component 230.

For example, if the user selects “COEX=> Jamsil baseball stadium”, the apparatus for providing a course information application according to an exemplary embodiment of the present invention may provide in more detail at least one course information for moving from COEX to the Jamsil baseball stadium, by analyzing among the event information component 230 a course set component 240 whose start location is “COEX”. The course information can be provided as at least one type of information selected from link information, text information, image information, and routing information.

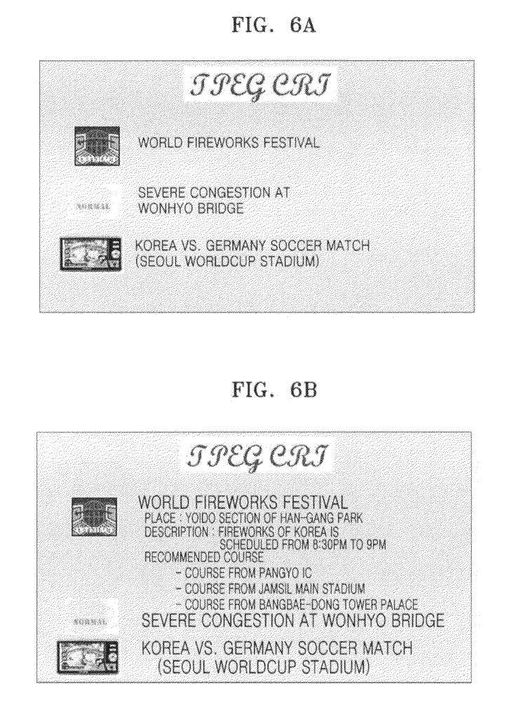

FIGS. 6A and 6B illustrate screen images in which a course information application is provided according to an exemplary embodiment of the present invention.

If the user inputs a user input signal for requesting a course information application into the apparatus for providing a course information application, an event list containing events, such as “World Fireworks Festival”, “severe congestion at Wonhyo Bridge”, and “Korea vs. Germany soccer match (Seoul Worldcup Stadium)”, is provided, along with thumbnail information of the events, on a screen on which the course information application is provided, as illustrated in FIG. 6A.

If a user input signal for selecting “World Fireworks Festival” is input through the user interface unit 440, the controller 420 can provide a screen image containing a place, a description, and at least one recommended course regarding “World Fireworks Festival”, as illustrated in FIG. 6B. Thus, the user can receive detailed information and recommended courses for a selected event.

If the user inputs a user input signal for selecting a course related to a user‘s location from among the recommended courses through the user interface unit 440, the controller 420 can provide a screen image for providing information on at least one course to the destination, using course information obtained by analyzing a course set component 240 according to the start location selected by the user.

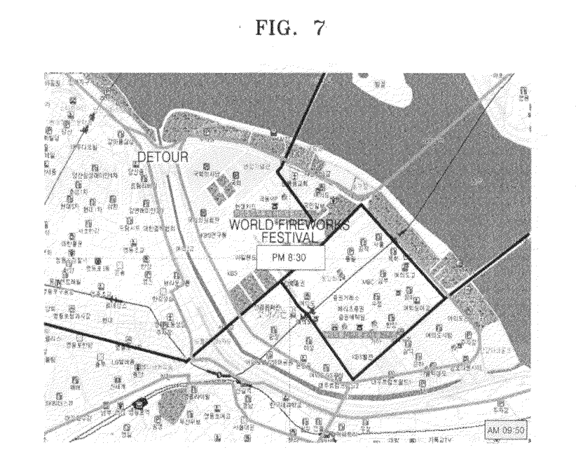

FIG. 7 illustrates a screen image in which a course information application is provided as an image according to an exemplary embodiment of the present invention.

When the user selects the event “World Fireworks Festival” in FIG. 6B, the image data illustrated in FIG. 7 can be provided to the user terminal, which is the apparatus for providing a course information application. As described above, the image data provided to the user terminal can be received through a broadcasting network or another path.

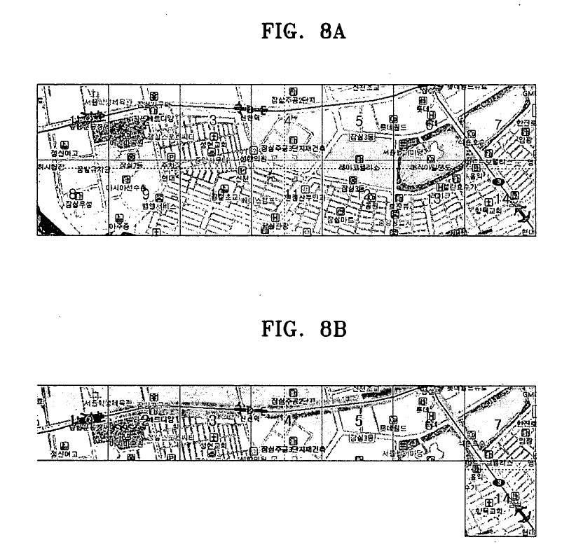

FIGS. 8A and 8B illustrate screen images in which a course information application is provided as an image according to an exemplary embodiment of the present invention.

FIG. 8A illustrates a case where image data is divided into a predetermined number of rectangles and received. In FIG. 8A, each rectangle indicates divided image data, and numbers displayed in the rectangles indicate index numbers of respective images. The index numbers can be displayed on a screen as illustrated in FIG. 8A, or not displayed on the screen, but instead used only as information to provide total map information using each image in the apparatus for providing a course information application.

If a recommended course belongs to image data of rectangles having index numbers 1 through 7 and 14, the system for generating a course information application can transmit only the image data of rectangles having index numbers 1 through 7 and 14, as illustrated in FIG. 8B. For example, if locator information to obtain image data is received through a broadcasting network, and image data is received from a communication device corresponding to the locator information through a communication network, the communication device can only transmit image data having index numbers to which a course is related. Thus, the amount of data of course information can be reduced, and if a transmission error occurs, only image data in which the transmission error has occurred can be retransmitted.

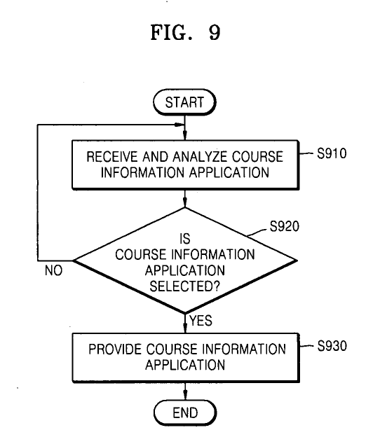

FIG. 9 is a flowchart illustrating a method of providing a course information application according to an exemplary embodiment of the present invention.

Referring to FIG. 9, a course information application including at least one piece of event information, and at least one piece of course information for each piece of the event information, is received and analyzed in operation S910.

If a user input signal for selecting the course information application is received in operation S920, a screen image for providing the course information application is formed and output in operation S930.

In operation S930, if a list of event information included in the course information application was previously provided, and if a user input signal for selecting one event from the event list is received, at least one of destination information, description information, and course information of the selected event, which are obtained by analyzing the course information application, can be provided. In addition, if a user input signal for selecting one piece of the provided course information is received, the selected course information can be provided as text data, map data, or image data.

If the course information includes a link ID, map data of the link ID can be searched and provided. In addition, if the course information is image data received through bi-directional communication, in order to obtain image data indicating a course included in the course information, image data may be requested to an external device based on locator information indicating a locator, the requested image data may be received from the external device, and the received image data may be provided.

If image information contains location information for representing a location on a map, current location information of the user may be checked, and a screen image for providing a current location of the user on the map, using the current location information of the user and the location information included in the image information, may be formed and provided.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems, so that the computer readable code is stored and executed in a distributed fashion.

As described above, exemplary embodiments of the present invention include an apparatus and method for providing CRI on which prediction information based on a past traffic situation for an event occurring in the future or a current traffic situation is reflected. In addition, at least one piece of course information, including the shortest course and a detour, can be provided to a user. In addition, the user can receive course information using a traffic and travel information service received through a broadcasting network, even without including a separate navigation device.

While the present invention has been particularly shown and described with reference to exemplary embodiments thereof, it will be understood by those of ordinary skill in the art that various changes in form and details may be made therein without departing from the spirit and scope of the present invention as defined by the following claims and their legal equivalents.

What is claimed is:

1. A course information providing apparatus comprising:
a signal processing unit which receives and analyzes a course information application comprising at least one piece of event information and at least one piece of course information for each piece of the event information;
a controller which forms a screen image providing the course information application; and
an output unit which outputs the screen image providing the course information application.

2. The course information providing apparatus of claim 1, wherein the signal processing unit processes the course information application, which is received using a Transport Protocol Experts Group (TPEG) protocol.

3. The course information providing apparatus of claim 1, further comprising a user interface unit which receives a user input signal requesting the course information application.

4. The course information providing apparatus of claim 1, wherein the controller forms a screen image providing an event list comprising at least one piece of event information from the course information application obtained by the analysis performed by the signal processing unit, and outputs the formed screen image to the output unit.

5. The course information providing apparatus of claim 3, wherein the user interface unit receives a user input signal for selecting at least one event in the event list, and
the controller forms a screen image providing at least one of destination information, description information, and course information of the event selected by the user input signal, and outputs the formed screen image to the output unit.

6. The course information providing apparatus of claim 1, further comprising a map data storage unit which stores location information of link identifications (IDs) and map data of the location information, wherein the course information obtained by the analysis performed by the signal processing unit comprises a link ID, and
the controller searches the map data storage unit for location information of the link ID and map data of the location information, and outputs the location information and map data found by the searching to the output unit.

7. The course information providing apparatus of claim 1, wherein the course information comprises locator information which indicates a locator used to obtain image data indicating the course information, and
the course information providing apparatus further comprises a communication unit which connects to an external device based on the locator information of the image data, and receives the image data.

8. The course information providing apparatus of claim 1, wherein the course information application comprises profile information which indicates information on receiver terminals capable of receiving and processing the course information application.

9. The course information providing apparatus of claim 1, wherein the event information comprises attribute information which contains at least one of an event name, description information of the event, and destination information of a place in which the event occurs; and course information of the event information.

10. The course information providing apparatus of claim 1, wherein the course information comprises start location information.

11. The course information providing apparatus of claim 1, wherein the course information comprises at least one piece of course set information comprising at least one of:
link information comprising a link identification (ID) which indicates the course;
text information comprising text which describes the course;
image information comprising image data which indicates the course; and
routing information which represents a course according to a Transport Protocol Experts Group (TPEG) standard.

12. The course information providing apparatus of claim 11, wherein the link information comprises a link type which indicates a type of a used link.

13. The course information providing apparatus of claim 11, wherein the text information comprises an encoding method of the text, or a language code which indicates information regarding the text information.

14. The course information providing apparatus of claim 11, wherein the image information comprises an image type which indicates a type of an image and whether the image is received through a bi-directional communication network or a broadcasting network, and
if the image type indicates that the image is received through a bi-directional communication network, the image data comprises locator information which indicates a locator used to obtain the image information.

15. The course information providing apparatus of claim 11, wherein the image information comprises location information for representing a location on a map image, and
the controller checks current location information of a user from an external device for checking a location of the user, and forms a screen image for providing a current location of the user on the map provided by the image data, using the current location information of the user and the location information comprised in the image information.

16. The course information providing apparatus of claim 11, wherein an image of map data is divided and transmitted, and the image information comprises rectangle information which indicates a relative location in the map, and a rectangle size which indicates a size of the divided and transmitted map data.

17. The course information providing apparatus of claim 11, wherein an image is divided and transmitted, and the image information further comprises index information which indicates an order or location of images obtained by dividing the image.

18. A course information providing method comprising:
receiving and analyzing a course information application comprising at least one piece of event information and at least one piece of course information for each piece of the event information;
forming a screen image for providing the course information application; and
outputting the screen image for providing the course information application.

19. The course information providing method of claim 18, wherein the course information application is transmitted using a Transport Protocol Experts Group (TPEG) protocol.

20. The course information providing method of claim 18, further comprising:
receiving a user input signal for receiving the course information application; and
forming a screen image for providing an event list comprising at least one piece of event information.

21. The course information providing method of claim 20, further comprising forming a screen image for providing at least one of destination information, description information, and course information of at least one event contained in the event list, which is selected by the user input signal.

22. The course information providing method of claim 18, wherein the course information comprises a link identification (ID), the course information method further comprising:
searching for map data of the link ID; and
providing the map data found by the searching.

23. The course information providing method of claim 18, wherein the course information comprises locator information used to obtain image data which indicates the course information, the course information providing method further comprising connecting to an external device based on the locator information of the image data, and receiving the image data from an external device.

24. The course information providing method of claim 18, wherein the image information comprises location information for representing a location on a map, the course information providing method further comprising:
checking current location information of a user; and
forming a screen image for providing a current location of the user on the map image contained in the image information or obtained through the image information, using the current location information of the user and the location information contained in the image information.

25. A computer readable recording medium which stores programs for executing a course information providing method comprising:
receiving and analyzing a course information application comprising at least one piece of event information and at least one piece of course information for each piece of the event information;
forming a screen image for providing the course information application; and
outputting the screen image for providing the course information application.

26. A course information providing method comprising generating a course information application and transmitting the course information application,
the course information application having a frame structure comprising an event field comprising at least one piece of event information,
the event field comprising at least one course information field for each piece of the event information.

27. The course information providing method of claim 26, wherein the event field further comprises at least one of a name field which indicates a name of an event, a description field which contains a description of the event, and a destination field which indicates a destination in which the event occurs.

28. The course information providing method of claim 26, wherein the course information field comprises at least one of:
a link information field comprising a link ID which indicates a course, and link type information which indicates a system of the link ID;
a text information field comprising text which describes the course, and an encoding method of the text or a language code which indicates information on the text;
an image information field comprising an image type which indicates a type of an image and whether the image is received through a bi-directional communication network or a broadcasting network, and a locator to obtain image data through the bi-directional communication network or an image received through the broadcasting network according to the image type; and
a routing information field which represents a course according to a Transport Protocol Experts Group (TPEG) standard.
